(19) United States
(12) Patent Application Publication
(10) Pub. No.: US 2006/0114948 A1
(43) Pub. Date: Jun. 1, 2006

(54) Workpiece processing system using a common imaged optical assembly to shape the spatial distributions of light energy of multiple laser beams

(76) Inventors: Ho Wai Lo, Portland, OR (US); Yunlong Sun, Beaverton, OR (US); Richard S. Harris, Portland, OR (US); Brian W. Baird, Oregon City, OR (US)

Correspondence Address: STOEL RIVES LLP, 900 SW FIFTH AVENUE, SUITE 2600, PORTLAND, OR, 97204-1268, US

(21) Appl. No.: 11/000,330

(22) Filed: Nov. 29, 2004

(51) Int. Cl. H01S 3/10; H01S 3/08

(52) U.S. Cl. 372/23; 372/101

(57) ABSTRACT

A workpiece processing system employs a common modular imaged optics assembly and an optional variable beam expander for optically processing multiple laser beams. In one embodiment, a laser and a fixed beam expander cooperate to produce a laser beam that propagates through a beam switching device to produce multiple laser beams that propagate along separate propagation path portions and subsequently merge into a common path portion through an imaged optics assembly and optional variable expander. The beam expander sets the shape of the laser beams in the form of a Gaussian spatial distribution of light energy. The imaged optics assembly shapes the Gaussian spatial distribution of the laser beams to form output beams of uniform spatial distribution. In an alternative embodiment, the beam switching device is removed and the laser beams propagate from separate laser sources associated with separate optional beam expanders.

### FEDERALLY SPONSORED RESEARCH AND DEVELOPMENT

Not applicable.

### TECHNICAL FIELD

This invention relates to lasers and, more particularly, to a method and an apparatus for increasing workpiece machining throughput by alternately switching a single laser beam among two or more beam paths such that one of the beam paths is employed for machining one workpiece while another the beam path is positioned for machining another workpiece.

### BACKGROUND OF THE INVENTION

Lasers are widely employed in a variety of research, development, and industrial operations including inspecting, processing, and micromachining a variety of electronic materials and substrates. For example, to repair a dynamic random access memory (“DRAM”), laser pulses are used to sever electrically conductive links to disconnect faulty memory cells from a DRAM device and then to activate redundant memory cells to replace the faulty memory cells. Because faulty memory cells needing link removals are randomly located, the links that need to be severed are randomly located. Thus, during the laser link repairing process, the laser pulses are fired at random pulse intervals. In another words, the laser pulses are running at a wide variable range of pulse repetition frequencies (“PRFs”), rather than at a constant PRF. For industrial processes to achieve greater production throughput, the laser pulse is fired at the target link without stopping the laser beam scanning mechanism. This production technique is referred to in the industry as “on-the-fly” (“OTF”) link processing. Other common laser applications employ laser pulses that are fired only when they are needed at random times.

However, the laser energy per pulse typically decreases with increasing PRF while laser pulse width increases with increasing PRF, characteristics that are particularly true for Q-switched, solid-state lasers. While many laser applications require randomly time-displaced laser pulses on the demand, these applications also require that the laser energy per pulse and the pulse width be kept substantially constant. For link processing on memory or other IC chips, inadequate laser energy will result in incomplete link severing, while excessive laser energy will cause unacceptable damage to the passivation structure or the silicon substrate. The acceptable range of laser pulse energies is often referred to as a “process window.” For many practical IC devices, the process window requires that laser pulse energy vary by less than 5 percent from a selected pulse energy value.

Various approaches have been implemented to ensure operation within a process window or to expand the process window. For example, U.S. Pat. No. 5,590,141 for METHOD AND APPARATUS FOR GENERATING AND EMPLOYING A HIGH DENSITY OF EXCITED IONS IN A LASANT, which is assigned to the assignee of this patent application, describes solid-state lasers having lasants exhibiting a reduced pulse energy drop off as a function of increasing PRF and, therefore, a higher usable PRF. Such lasers are, therefore, capable of generating more stable pulse energy levels when operated below their maximum PRFs.

U.S. Pat. No. 5,265,114 for SYSTEM AND METHOD FOR SELECTIVELY LASER PROCESSING A TARGET STRUCTURE OF ONE OR MORE MATERIALS OF A MULTIMATERIAL, MULTILAYER DEVICE, which is also assigned to the assignee of this patent application, describes using a longer laser wavelength such as 1,320 nanometers (“nm”) to expand the link process window to permit a wider variation of the laser pulse energy during the process.

U.S. Pat. No. 5,226,051 for LASER PUMP CONTROL FOR OUTPUT POWER STABILIZATION describes a technique of equalizing the laser pulse energy by controlling the electrical current of the pumping diodes. The technique works well in practical applications employing a laser PRF below about 25 KHz or 30 KHz.

The above-described laser processing applications typically employ infrared (“IR”) lasers having wavelengths from 1,047 nm to 1,324 nm, running at PRFs not over about 25 to 30 KHz. However, production needs are demanding much higher throughput, so lasers should be capable of operating at PRFs much higher than about 25 KHz, such as 50 KHz to 60 KHz or higher. In addition, many laser processing applications are improved by employing ultraviolet (“UV”) energy wavelengths, which are typically less than about 400 nm. Such UV wavelengths may be generated by subjecting an IR laser to a harmonic generation process that stimulates the second, third, or fourth harmonics of the IR laser. Unfortunately, due to the nature of the harmonic generation, the pulse-to-pulse energy levels of such UV lasers are particularly sensitive to time variations in PRF and laser pulse interval.

U.S. Pat. No. 6,172,325 for LASER PROCESSING POWER OUTPUT STABILIZATION APPARATUS AND METHOD EMPLOYING PROCESSING POSITION FEEDBACK, which is also assigned to the assignee of this patent application, describes a technique of operating the laser at a constant high repetition rate in conjunction with a position feedback-controlled laser pulse picking or gating device to provide laser pulse picking on demand at a random time interval that is a multiple of the laser pulse interval. This technique affords good laser pulse energy stability and high throughput.

A typical laser pulse picking or gating device is an acousto-optic modulator (“AOM”) or electro-optic modulator (“EOM”, also referred to as a Pockels cell). Typical EOM material such as KD*P or KDP suffers from relatively strong absorption at the UV wavelengths, which results in a lower damage threshold of the material at the wavelength used and local heating along the laser beam path within the device, causing changes of the half wave-plate voltage of the device. Another disadvantage of the EOM is its questionable ability to perform well at a repetition rate over 50 KHz.

AOM material is, on the other hand, quite transparent to UV light of 250 nm up to IR light of 2,000 nm, which allows the AOM to perform well throughout typical laser wavelengths within the range. An AOM can also easily accommodate the desirable gating of pulses at a repetition rate of up to a few hundred KHz. One disadvantage of the AOM is its limited diffraction efficiency of about 75-90 percent.

FIG. 1 shows a typical prior art AOM 10 driven by a radio frequency (“RF”) driver 12 and employed for a laser pulse picking or gating application, and FIGS. 2A to 2D (collectively, FIG. 2) show corresponding prior art timing graphs for incoming laser pulses 14, AOM RF pulses 15, and AOM output pulses 16 and 20. FIG. 2A shows constant repetition rate laser pulses 14a-14k that are emitted by a laser (not shown) and propagated to AOM 10. FIG. 2B demonstrates two exemplary schemes for applying RF pulses 15 to AOM 10 to select which ones of laser pulses 14a-14k, occurring at corresponding time periods 22a-22k, are propagated toward a target. In a first scheme, a single RF pulse 15cde (shown in dashed lines) is extended to cover time periods 22c-22e corresponding to laser pulses 14c, 14d, and 14e; and, in a second scheme, separated RF pulses 15c, 15d, and 15e are generated to individually cover the respective time periods 22c, 22d, and 22e for laser pulses 14c, 14d, and 14e. FIGS. 2C and 2D show the respective first order beam 20 and zero order beam 16 propagated from AOM 10, as determined by the presence or absence of RF pulses 15 applied to AOM 10.

Referring to FIGS. 1 and 2, AOM 10 is driven by RF driver 12. When no RF pulses 15 are applied to AOM 10, incoming laser pulses 14 pass through AOM 10 substantially along their original beam path and exit as beam 16, typically referred to as the zero order beam 16. When RF pulses 15 are applied to AOM 10, part of the energy of incoming laser pulses 14 is diffracted from the path of the zero order beam 16 to a path of a first order beam 20. AOM 10 has a diffraction efficiency that is defined as the ratio of the laser energy in first order beam 20 to the laser energy in incoming laser pulses 14. Either first order beam 20 or zero order beam 16 can be used as a working beam, depending on different application considerations. For simplicity, laser pulses 14 entering AOM 10 will hereafter be referred as “laser pulses” or “laser output,” and pulses delivered to the target, because they are picked by AOM 10, will be referred to as “working laser pulses” or “working laser output.”

When first order beam 20 is used as the working beam, the energy of the working laser pulses can be dynamically controlled from 100 percent of its maximum value down to substantially zero, as the power of RF pulses 15 changes from their maximum power to substantially zero, respectively. Because the practical limited diffraction efficiency of an AOM under an allowed maximum RF power load is about 75 percent to 90 percent, the maximum energy value of the working laser pulses is about 75 percent to 90 percent of the energy value in laser pulses 14. However, when zero order beam 16 is used as the working beam, the energy of the working laser pulses can be dynamically controlled from 100 percent of the maximum energy in laser pulses 14 down to 15 percent to 20 percent of the maximum value, as the power of RF pulses 15 changes from substantially zero to its maximum power, respectively. For memory link processing, for example, when no working laser pulse is demanded, no leakage of system laser pulse energy is permitted, i.e., the working laser pulse energy should be zero, so first order laser beam 20 is preferably used as the working beam.

With reference again to FIG. 2, RF pulses 15 are applied to AOM 10 at random time intervals and only when working laser pulses are demanded, in this case, at random integral multiples of the laser pulse interval. The random output of working laser pulses results in random variable thermal loading on AOM 10. Variable thermal loading causes geometric distortion and temperature gradients in AOM 10, which cause gradients in its refractive index. The consequences of thermal loading distort a laser beam passing through AOM 10, resulting in deteriorated laser beam quality and instability in the laser beam path or poor beam positioning accuracy. These distortions could be corrected to some degree if they could be kept constant. However, when the system laser pulses are demanded randomly, such as in laser link processing, these distortions will have the same random nature and cannot be practically corrected.

Test results on an AOM device, such as a Model N23080-2-1.06-LTD, made by NEOS Technologies, Melbourne, Fla., showed that with only two watts of RF power, the laser beam pointing accuracy can deviate as much as one milliradian when the RF is applied on and off randomly to the AOM. This deviation is a few hundred times greater than the maximum deviation allowed for the typical memory link processing system. Laser beam quality distortion resulting from the random thermal loading on the AOM 10 will also deteriorate the focusability of the laser beam, resulting in a larger laser beam spot size at the focusing point. For applications such as the memory link processing that require the laser beam spot size to be as small as possible, this distortion is very undesirable.

What is needed, therefore, is an apparatus and a method for randomly picking working laser pulses from a high repetition rate laser pulse train without causing distortion of the laser beam and adversely affecting positioning accuracy caused by random thermal loading variation on the AOM. What is also needed is an apparatus and a method of generating working laser pulses having constant laser energy per pulse and constant pulse width on demand and/or on-the-fly at a high PRF and with high accuracy at different pulse time intervals for variety of laser applications such as laser link processing on memory chips. Moreover, what is needed is an efficient, high-throughput apparatus and method for utilizing the working laser pulses.

### SUMMARY OF THE INVENTION

An object of this invention is, therefore, to provide an apparatus and a method for picking laser pulses on demand from a high repetition rate pulsed laser.

The following are several of the advantages of the invention. Embodiments of this invention perform such pulse picking with minimal thermal loading variation on the AOM to minimize distortion of the laser beam and positioning accuracy. They include an apparatus and a method for generating system on demand laser pulses having stable pulse energies and stable pulse widths at selected wavelengths from the UV to near IR and at high PRFs for high-accuracy laser processing applications, such as memory link severing. The embodiments of this invention provide an efficient, high-throughput apparatus and method for utilizing the working laser pulses.

A workpiece processing system of this invention employs a laser coupled to a beam switching device that causes a laser beam or laser pulses to switch between first and second beam positioning heads such that when the first beam positioning head directs the laser beam to process a first workpiece, the second beam positioning head moves to a next target location on a second workpiece or a second set of locations on the first workpiece. When the first beam positioning head completes processing of the first workpiece and the second beam positioning head reaches its target position, the beam switching device causes the beam to switch to the second beam positioning head and then the second beam positioning head directs the laser beam to target locations on the second workpiece while the first beam positioning head moves to its next target position.

An advantage of the present laser beam switching system is that the first and second workpieces receive almost the full power of the laser beam for processing. The total time utilization of the laser beam is increased by almost a factor of two, depending on the processing-to-moving time ratio. This greatly increases system throughput without significantly increasing system cost.

A preferred beam switching device includes first and second AOMs that are positioned adjacent to each other so that the laser beam (or laser pulses) normally pass undeflected through the AOMs and terminate on a beam blocker. When RF energy is applied to the first AOM, about 90 percent of the laser beam is diffracted as a first laser beam and 10 percent remains as a residual laser beam that terminates in the beam blocker. Likewise, when RF energy is applied to the second AOM, about 90 percent of the laser beam is diffracted as a second laser beam and 10 percent remains as a residual laser beam that terminates in the beam blocker. In this embodiment, the laser generating the laser beam is constantly running at its desired pulse repetition rate.

Employing the beam switching device is advantageous because constant operation of the laser eliminates thermal drifting of the laser output. Moreover, by operating the first and second AOMs with pulse picking methods of this invention, thermal loading variations in the AOMs will be minimized, thereby increasing laser beam positioning accuracy.

Another advantage of employing the first and second AOMs as a beam switching device is that they can operate as a laser power control device, eliminating a need for a separate laser power controller in a typical laser-based workpiece processing system. Power control is possible because the response times of the AOMs are sufficiently fast for programming laser pulse amplitudes of the switched laser beam during processing of individual target locations on the workpieces. A typical laser processing application is blind via formation in etched-circuit boards, in which it is often necessary to reduce the laser pulse energy when the laser beam reaches the bottom of the via being formed.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a simplified schematic view of a prior art AOM device and an RF driver, transmitting a zero order beam, a first order beam, or both of them.

FIGS. 2A-2D are corresponding prior art timing graphs of, respectively, laser pulses, RF pulses, and first and zero order AOM output laser pulses.

FIGS. 3A-3C are corresponding exemplary timing graphs of, respectively, laser outputs, RF pulses, and working laser outputs as employed in a preferred embodiment.

FIGS. 4A-4C are alternative corresponding exemplary timing graphs of, respectively, laser outputs, RF pulses, and working laser outputs that demonstrate the use of the AOM for energy control of the working laser outputs.

FIG. 5 is a simplified schematic block diagram of a laser beam switching system of this invention.

FIG. 6 is a waveform timing diagram representing operational timing relationships among various components of the laser beam switching system of FIG. 5.

FIG. 7 is a simplified schematic block diagram representing a preferred dual AOM laser beam switching device for use with this invention.

FIG. 8 is a waveform timing diagram representing operational timing relationships among various components of a laser beam switching system employing the dual AOM switching device of FIG. 7.

FIG. 9 is a simplified schematic block diagram of a typical workpiece processing system employing the laser beam switching device of FIG. 7.

FIG. 10 is a waveform timing diagram representing operational timing relationships among various components of the workpiece processing system of FIG. 9.

FIGS. 11A and 11B are simplified block diagrams representing workpiece processing systems of this invention employing a common optical processing path for multiple laser beams propagating from one and two laser sources, respectively.

FIG. 12 is a simplified schematic block diagram representing an alternative workpiece processing system of this invention employing a fast EOM and a polarizing beam splitter to implement a laser beam switching device of this invention.

FIG. 13 is a simplified pictorial block diagram representing an alternative laser beam switching system employing a fast steering mirror for switching a laser beam along alternate first and second pathways.

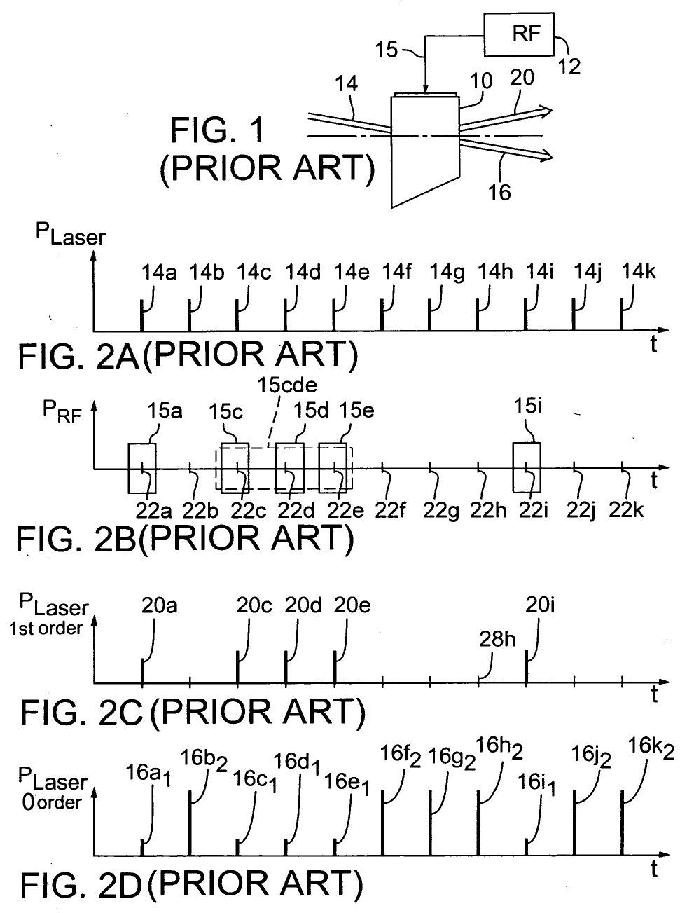

### DETAILED DESCRIPTION OF PREFERRED EMBODIMENTS

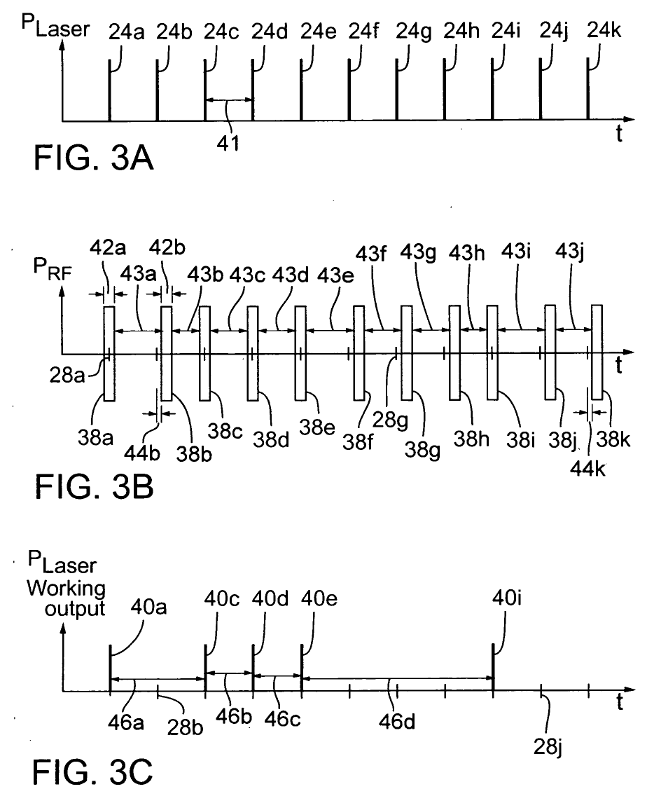

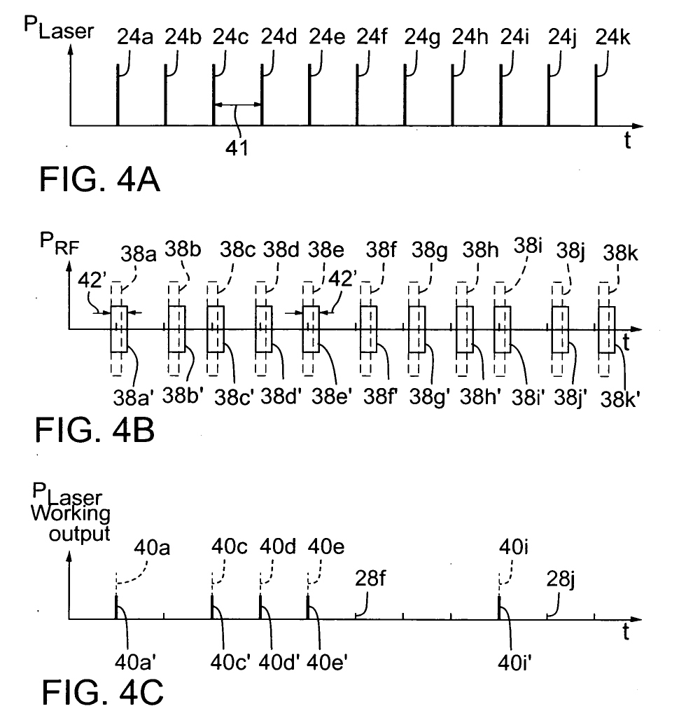

Thermal loading variations in AOMs, such as prior art AOM 10, can be mitigated by employing pulse picking and laser power control methods shown with reference to FIGS. 3A-3C and 4A-4C, respectively. FIGS. 3A-3C (collectively, FIG. 3) show corresponding timing graphs of laser outputs 24a-24k (collectively, laser outputs 24), RF pulses 38a-38k (collectively, RF pulses 38) applied to prior art AOM 10, and working laser outputs 40a, 40c, 40d, 40e, and 40i (collectively, working laser outputs 40). In particular, FIG. 3A shows laser outputs 24a-24k that are emitted by a laser (not shown) at a constant repetition rate and separated by substantially identical laser output intervals 41. In typical embodiments, the laser output repetition rate may range from about 1 KHz up to about 500 KHz. Exemplary laser output repetition rates range from about 25 KHz to greater than about 100 KHz. For link processing embodiments, each of working laser outputs 40 preferably includes a single laser pulse having a multiple nanosecond pulse width. However, skilled persons will recognize that each of working laser outputs 40 may include a burst of one or more laser pulses, such as disclosed in U.S. Pat. No. 6,574,250 for LASER SYSTEM AND METHOD FOR PROCESSING A MEMORY LINK WITH A BURST OF LASER PULSES HAVING ULTRASHORT PULSE WIDTHS, which is assigned to assignee of this patent application, or bursts of one or more pulses having pulse widths ranging from about 10 picoseconds to about 1,000 picoseconds.

FIG. 3B shows a preferred RF pulse picking scheme employing RF pulses 38 having pulse durations, such as 42a and 42b (collectively, RF pulse durations 42) separated by RF pulse intervals 43a-43j (collectively, RF pulse intervals 43) that are substantially regular or uniform to keep thermal loading variations on AOM 10 within a preassigned operational tolerance. Such tolerance may be a specific thermal load window, but the preassigned tolerance may also or alternatively be windows of spot size or beam position accuracy. In one embodiment, the thermal loading variation is maintained within 5 percent and/or the beam pointing accuracy is maintained within 0.005 milliradian. In a preferred embodiment, at least one of RF pulses 38 is generated to correspond with each of laser outputs 24.

Whenever one of working laser outputs 40 is demanded to impinge on a target such as an electrically conductive link, one of RF pulses 38 is applied to AOM 10 in coincidence with one of laser outputs 24 such that it is transmitted through AOM 10 and becomes the demanded one of working laser outputs 40.

In FIG. 3B, the coincident RF pulses 38 are RF pulses 38a, 38c, 38d, 38e, and 38i. FIG. 3C shows the resulting corresponding working laser outputs 40a, 40c, 40d, 40e, and 40i. When no working laser output is demanded to correspond with laser outputs 24, RF pulses 38 are applied to AOM 10 in noncoincidence with corresponding ones of laser outputs 24. In FIG. 3B, the noncoincident RF pulses 38 are RF pulses 38b, 38f, 38g, 38h, 38j, and 38k. FIG. 3C shows that no working laser outputs 40 correspond with noncoincident RF pulses 38.

The noncoincident RF pulses 38 are preferably offset from the initiations of respective laser outputs 24 by time offsets 44 that are longer than about 0.5 microsecond. Skilled persons will appreciate that while time offsets 44 are shown to follow laser outputs 24, time offsets 44 could alternatively precede laser outputs 24 by a sufficient time to prevent targeting of laser working outputs 40. Thus, RF pulse intervals 43 surrounding one of noncoincident RF pulses 38 may be shorter (such as RF pulse intervals 43b and 43h) than the overall average RF pulse interval 43 (such as 43c, 43d, 43f, 43g, and 43j) or longer (such as RF pulse intervals 43a, 43e, and 43i) than the average RF pulse intervals 43.

With reference again to FIG. 3C, nonimpingement intervals 46b and 46c between working laser outputs 40c and 40d and between working laser outputs 40d and 40e, respectively, are about the same as the laser output interval 41. The nonimpingement intervals 46a and 46d between working laser outputs 40a and 40c and between working laser outputs 40e and 40i, respectively, are roughly integer multiples of the laser output interval 41.

Skilled persons will appreciate that even though working laser outputs 40 are preferably first order beam 20 for most applications, such as link processing, working laser outputs 40 may be zero order beam 16 where leakage is tolerable and higher working laser output power is desirable.

In a preferred embodiment, the coincident and noncoincident RF pulses 38 not only employ about the same RF energy, which is the product of an RF power value and an RF duration, but also employ about the same RF power value and about the same RF duration.

FIGS. 4A-4C (collectively, FIG. 4) show corresponding timing graphs of laser outputs 24, RF pulses 38 applied to AOM 10, and working laser outputs 40 that demonstrate how AOM 10 can be additionally employed to control the output power of working laser outputs 40. FIG. 4A is identical to FIG. 3A and is shown for convenience only. FIGS. 4B and 4C show RF pulses 38′ and working laser outputs 40′, with the corresponding RF pulses 38 and working laser outputs 40 shown superimposed on them in dashed lines for convenience. The energy values of working laser outputs 40′ are attenuated by applying less RF power to AOM 10 for RF pulses 38′ than for RF pulses 38; however, the RF pulse durations 42′ are increased for RF pulses 38′ over the RF durations 42 employed for RF pulses 38 to maintain a substantially constant product of RF power value and RF duration in order to maintain substantially constant thermal loading on AOM 10. This technique permits on-demand selection for a continuum of output powers between working laser outputs 40 or 40′ without substantial variance in thermal loading on AOM 10. Skilled persons will appreciate that the RF power values and RF durations 42 of the noncoincident RF pulses 38 can be kept as original or can be altered to be within a specified tolerance of the RF loading variation of the coincident RF pulses 38′.

RF pulse duration 42′ is preferably selected from about one microsecond to about one-half of laser output interval 41, more preferably shorter than 30 percent of laser output interval 41. For example, if the laser repetition rate is 50 KHz and laser output interval 41 is 20 microseconds, RF pulse duration 42′ can be anywhere between one microsecond and ten microseconds. The minimum RF pulse duration 42 or 42′ is determined by the laser pulse jittering time and the response time of AOM 10. It is preferable to initiate corresponding ones of RF pulses 38 and 38′ surrounding the midpoints of laser outputs 24. Likewise, it is preferable for RF pulses 38 and 38′ to be delayed or offset about half of the minimum RF pulse duration from the initiation of corresponding laser outputs 24.

It will be appreciated that the RF power of RF pulses 38 applied to AOM 10 can be adjusted to control the energy of working laser outputs 40 and 40′ to meet target processing needs, while RF pulse durations 42 and 42′ of RF pulses 38 and 38′ can be controlled accordingly to maintain a substantially constant RF energy or arithmetic product of the RF powers and durations of RF pulses 38 and 38′.

The above-described techniques for employing an AOM in a workpiece processing application address beam steering accuracy and process window requirements, but do not address workpiece processing throughput and efficiency concerns. Employing a single laser for workpiece processing is time-inefficient because significant time and laser power is wasted while moving the laser output and workpiece target location relative to one another. Using a laser beam for an application, such as etched-circuit board via formation, typically results in only 50 percent laser beam utilization time because of the time needed to move the beam between target locations. Beam splitting does not correct this low time utilization problem. Prior workers have employed multiple laser beams to improve processing throughput, but the additional cost and wasted laser power is still a concern.

This invention provides apparatus and methods for improving the throughput and efficiency of a single laser workpiece processing system. In this invention, AOMs employing pulse picking techniques are used in combination with a laser beam switching, or multiplexing, technique to improve workpiece processing and efficiency.

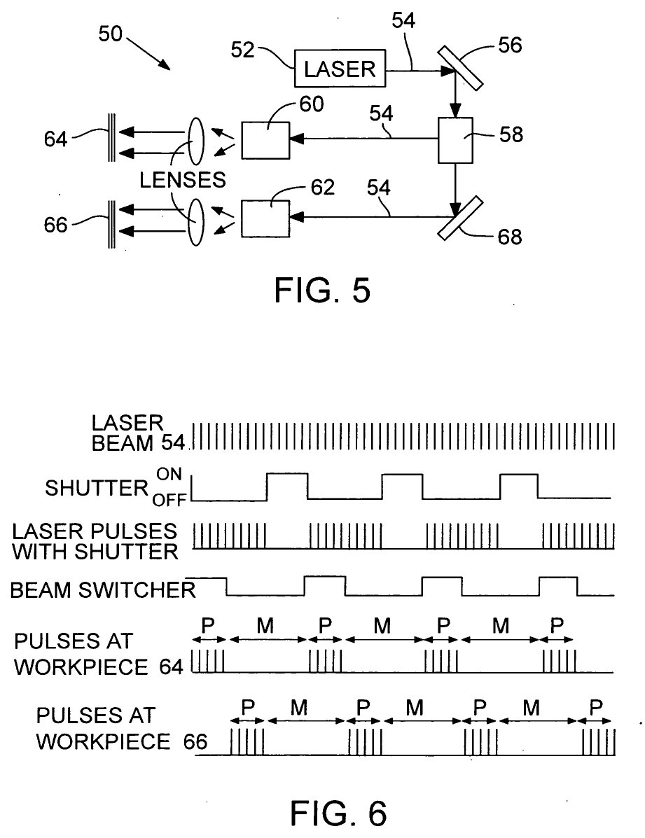

FIGS. 5 and 6 represent a laser beam switching system 50 and associated timing aspects of this invention in which a laser emits laser pulses 54 that are reflected by an optional fold mirror 56 to a beam switching device 58. Beam switching device 58 causes laser pulses 54 to switch between first and second beam positioning heads 60 and 62 such that when first beam positioning head 60 is causing laser pulses 54 to process a target location on a first workpiece 64, second beam positioning head 62 is moving to a target location on a second workpiece 66. Laser pulses 54 are directed from beam switching device 58 to beam positioning head 62 by an optional fold mirror 68. When first beam positioning head 60 completes processing of workpiece 64, either an optional shutter (not shown), such as a Q-switch, turns laser 52 off, as shown in FIG. 6, or laser pulses 54 are dumped to a beam blocker (not shown). When second beam positioning head 62 reaches its target position, laser pulses 54 are switched on by the shutter and second beam positioning head 62 directs laser pulses 54 to target locations on workpiece 66 while first beam positioning head 60 moves to its next target position. FIG. 6 represents workpiece processing times as intervals P and positioner move times between target positions as intervals M.

An advantage of laser beam switching system 50 is that first and second workpieces 64 and 66 alternately receive almost the full power of laser pulses 54 for processing. The total time utilization of laser pulses 54 is increased by almost a factor of two, depending on the processing-to-moving time ratio. This greatly increases system throughput without significantly increasing system cost.

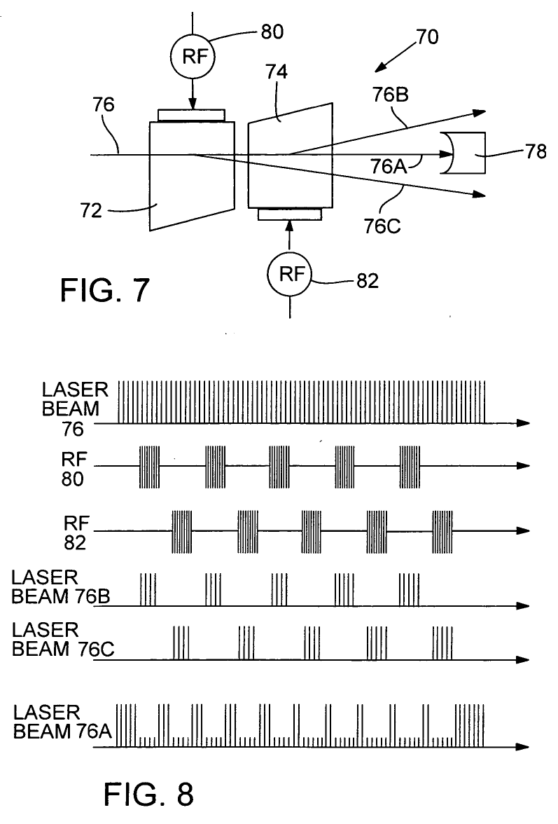

FIGS. 7 and 8 show a preferred beam switching device 70 and related timing relationships. Beam switching device 70 includes first and second AOMs 72 and 74 positioned in optical series relation so that a laser beam or laser pulses 76 normally pass undeflected through AOMs 72 and 74 and terminate as laser beam 76A on a beam blocker 78. However, when a first RF driver 80 applies about 6 Watts of 85 MHz RF signal to first AOM 72, about 90 percent of laser beam 76 is diffracted as laser beam 76B and 10 percent remains as laser beam 76A. Likewise, when a second RF driver 82 applies about 6 Watts of 85 MHz RF signal to second AOM 74, about 90 percent of laser beam 76 is diffracted as laser beam 76C and 10 percent remains as laser beam 76A. In this embodiment, the laser generating laser beam 76 is constantly running at its desired pulse repetition rate.

When employing beam switching device 70, no shutter or Q-switch is needed if time intervals are required when switching between laser beams 76B and 76C because it is necessary only to shut off the RF signals applied to both first and second AOMs 72 and 74, thereby dumping all of laser beam 76 on beam blocker 78.

Beam switching device 70 is advantageous because constant operation of the laser eliminates thermal drifting of the laser output. Moreover, by operating AOMs 72 and 74 with the pulse picking methods described with reference to FIGS. 3 and 4, thermal loading variations will be minimized, thereby increasing laser beam positioning accuracy. Each of first and second AOMs 72 and 74 is preferably a Model N30085, manufactured by NEOS Technologies, Inc., of Melbourne, Fla. The N30085 AOM has a specified 90 percent diffraction efficiency when driven with two Watts of 85 MHz RF power.

Another advantage of beam switching device 70 is that it can operate as a laser power control device, eliminating a need for a separate laser power controller in a typical laser-based workpiece processing system. Power control is possible because the response times of AOMs 72 and 74 are sufficiently fast for programming laser pulse amplitudes of laser beams 76B and 76C during processing of single target locations in workpieces. A typical laser processing application is blind via formation in etched-circuit boards, in which it is often necessary to reduce the laser pulse energy when the laser beam reaches the bottom of the via being formed.

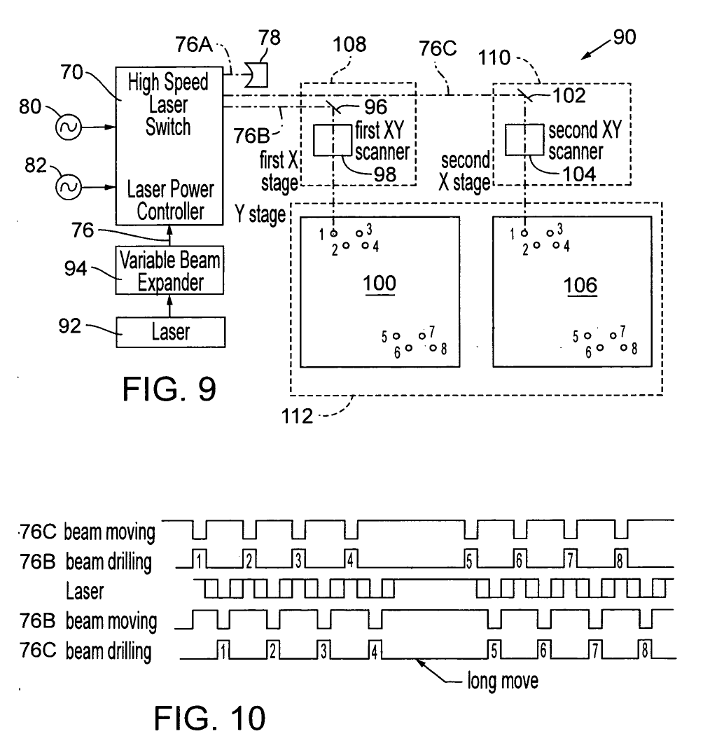

FIGS. 9 and 10 show, respectively, a typical workpiece processing system 90 employing beam switching device 70 and related operational timing relationships. A laser 92 and a variable beam expander 94 cooperate to produce laser beam 76 that propagates through beam switching device 70, which operates as described with reference to FIGS. 7 and 8 to produce laser beams 76A, 76B, and 76C. Laser beam 76A terminates in beam blocker 78. Laser beam 76B is reflected by an optional fold mirror 96 and directed by a first XY scanner 98 to target locations 1, 2, 3, and 4 on a first workpiece 100. Likewise, laser beam 76C is reflected by an optional fold mirror 102 and directed by a second XY scanner 104 to target locations 1, 2, 3, and 4 on a second workpiece 106. First and second XY scanners 98 and 104 are mounted on respective first and second X positioning stages 108 and 110, and first and second workpieces 100 and 106 are mounted on a Y positioning stage 112. Skilled workers will understand that the scanners and workpieces are mounted on a split axis configured positioner system but that planar and stacked configurations may alternatively be employed. Skilled workers will also understand that the target locations on the first and second workpieces may be on a common substrate and/or may not share corresponding target locations.

FIG. 10 shows laser beam 76B processing (drilling) target location 1 on workpiece 100 while second XY scanner 104 is moving the position of laser beam 76C to target location 1 on workpiece 106. When laser beam 76C is processing target location 1 on workpiece 106, first XY scanner 98 is moving the position of laser beam 76B to target location 2 on workpiece 100. This process continues for target locations 2, 3, and 4 until processing of target location 4 on workpiece 106 is complete, at which time first and second X positioning stages 108 and 110 and Y positioning stage 112 execute a long move to position first and second XY scanners 98 and 104 over target locations 5, 6, 7, and 8 of respective workpieces 100 and 106. The X and Y linear positioning stages operate in constant motion in cooperation with the XY scanners. Positioning systems suitable for use with this invention are described in U.S. Pat. No. 5,751,585 for HIGH SPEED, HIGH ACCURACY MULTI-STAGE TOOL POSITIONING SYSTEM, which is assigned to the assignee of this patent application.

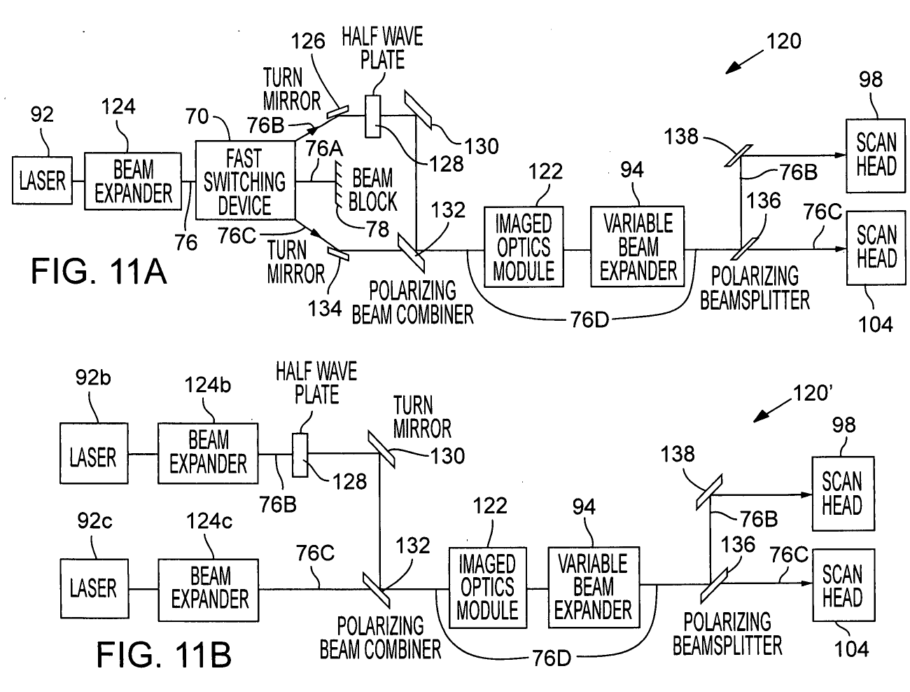

FIG. 11A shows a workpiece processing system 120 of this invention that employs a common modular imaged optics assembly 122 and variable beam expander 94 for optically processing both laser beams 76B and 76C. In this embodiment, laser 92 and an optional fixed beam expander 124 cooperate to produce laser beam 76 that propagates through beam switching device 70, which operates as described with reference to FIGS. 7 and 8 to produce laser beams 76A, 76B, and 76C. Laser beams 76B and 76C propagate along separate propagation path portions. A first turn mirror 126 directs laser beam 76B through a half-wave plate 128, which changes the polarization state of laser beam 76B by 90 degrees relative to the polarization state of laser beam 76C. The 90 degree phase-displaced laser beam 76B is directed by a second turn mirror 130 to a polarizing beam combiner 132. Laser beam 76C is directed by a third turn mirror 134 to polarizing beam combiner 132, which combines into a common propagation path portion the separate path portions along which laser beams 76B and 76C propagate. Laser beams 76B and 76C merge into a common laser beam 76D, which propagates along the common path portion through imaged optics assembly 122 and optional variable expander 94 and into a polarizing beam splitter 136. Second polarizing beam splitter 136 separates common laser beam 76D into laser beams 76B and 76C. Laser beam 76B is directed by a fourth turn mirror 138 into, for example, first XY scanner 98; and laser beam 76C is directed into, for example, second XY scanner 104.

Beam expander 124 sets the shape of laser beams 76B and 76C in the form of a Gaussian spatial distribution of light energy. Imaged optics assembly 122 shapes the Gaussian spatial distribution of lasers 76B and 76C to form output beams of uniform spatial distribution for delivery to XY scanners 98 and 104. A preferred imaged optics assembly is of a diffractive beam shaper type such as that described in U.S. Pat. No. 5,864,430.

FIG. 11B shows an alternative workpiece processing system 120′, in which beam switching device 70 is removed and laser beams 76B and 76C propagate from separate laser sources 92b and 92c, respectively. The size of laser beam 76B is set by a beam expander 124b, and the size of laser beam 76C is set by a beam expander 124c. The use of separate laser sources 92b and 92c facilitates optical component configurations in which one or more of turn mirrors 126, 130, and 134 can be eliminated, as shown in FIG. 11B.

Each of workpiece processing systems 120 and 120′ is advantageous because only one set of expensive beam imaging optics is required. Moreover, for workpiece processing system 120, employing beam switching device 70 permits implementation with smaller optical components because switching is accomplished with a smaller beam width than that which would be found with downstream switching components.

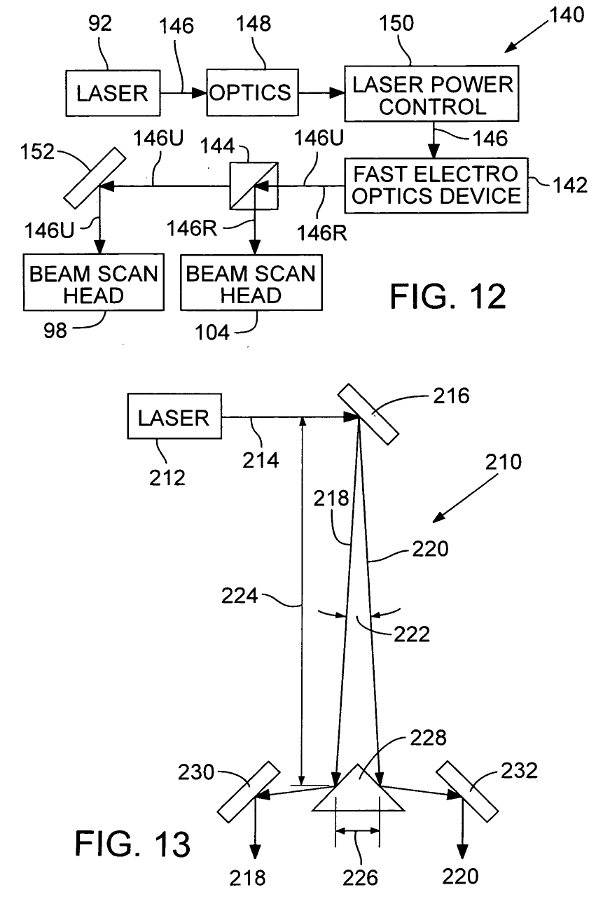

FIG. 12 shows another alternative workpiece processing system 140 of this invention employing a fast EOM 142 and a polarizing beam splitter 144 to implement switching of a laser beam 146 between first and second XY beam scanning heads 98 and 104. In workpiece processing system 140, laser 92 emits laser beam 146, which propagates through and is optically processed by an optics module 148 and a laser power controller 150. Laser beam 146 exits laser power controller 150 and enters fast EOM 142, which alternately polarizes laser beam 146 into respective unrotated-polarization and rotated-polarization laser beams 146U and 146R. Polarizing beam splitter 144 receives unrotated laser beam 146U and directs it to a turn mirror 152 to first XY scanning head 98. Polarizing beam splitter 144 receives rotated laser beam 146R and directs it to second XY scanning head 104.

A disadvantage of workpiece processing system 140 is that current practical EOMs are limited in laser pulse repetition rates and are unable to withstand high amounts of ultraviolet laser beam power. Another limitation is that dumping unneeded laser beam energy requires shuttering or turning off laser 92, such as by a Q-switch positioned inside the cavity of laser 92.

On the other hand, workpiece processing system 140 is advantageous because it is simpler than the dual AOM beam switching device 70 described with reference to FIG. 7 and has a high extinguishing ratio that allows practically all of the power in laser beam 146 to impinge on target locations as laser beams 146U and 146R.

FIG. 13 shows an alternative embodiment of a laser beam switching system 210 in which a laser 212 emits a laser beam 214 that is deflected by a fast steering mirror (“FSM”) 216 along alternate first and second paths 218 and 220. FSM 216 preferably employs a mirror having a deflection angle that is controlled by materials that translate voltages into angular displacements. FSM 216 operates similar to a galvanometer driven rotating mirror but at angular speeds up to 10 times faster than galvanometers and over an angular deflection range 222 of up to about 5 milliradians. Deflecting a typical laser beam diameter with such a limited angular deflection range requires a path length 224 that is sufficiently long, preferably about one meter, to separate first and second beam paths 218 and 220 by a sufficient distance 226, preferably about 10 millimeters, for inserting between them an HR coated right angle prism 228 that further separates and directs first and second beams baths 218 and 220 for reflection by respective first and second turning mirrors 230 and 232 to associated laser beam scanning heads (not shown). Switching laser beam 214 at a location where it is smallest in diameter, such as before any beam expander, would minimize path length 224 required to sufficiently separate first and second paths 218 and 220 where they are reflected by right angle prism 228.

FSM 216 may be a two-axis device that could further provide switching of laser beam 214 to more than two positions. For example, laser beam 214 could be directed to a beam blocker during long moves as described with reference to FIGS. 9 and 10 to maintain constant thermal conditions in laser 212 and minimize duty cycle related laser beam power stability problems.

Laser beam switching system 210 allows implementing a single laser workpiece processing system having the same workpiece processing throughput as a two laser system, provided the move times are over 3 ms and the workpiece processing time and laser beam switching time are less than 1.0 ms.

Laser beam switching system 210 is advantageous because the use of a single laser and associated optics reduces cost by 20 percent to 40 percent, depending on the type of laser required, as compared with a two laser system.

Skilled workers will recognize that portions of this invention may be implemented differently from the implementations described above for preferred embodiments. For example, galvonometer and rotating mirror devices may also be used as laser beam switching devices; IR, visible, and UV lasers may be employed; target locations may be on single or multiple workpieces; laser beam switching may be effected to more than two or three beam paths; multiple lasers may be employed and each of their respective laser outputs switched among multiple paths; AOMs may be switched by single or multiple RF sources; and the scanning heads employed may further include galvanometers, FSMs, and other than XY coordinate positioning techniques.

It will be obvious to skilled workers that many other changes may be made to the details of the above-described embodiments without departing from the underlying principles of the invention. The scope of the present invention should, therefore, be determined only by the following claims.

1. A lower cost, compact laser beam switching system, comprising:
first and second laser beam components propagating along respective first and second propagation path portions, each of the first and second laser beam components characterized by a state of an optical property;
a set of one or more optical components cooperating to impart a relative change in the states of the optical property of the first and second laser beam components and to combine the first and second propagation path portions into a common propagation path portion along which the first and second laser beam components propagate;
an imaged optics assembly positioned along the common propagation path portion to form beam-shaped first and second laser beam components, the imaged optics assembly shaping spatial distributions of light energy of the first and second laser beam components; and
a beam splitter positioned to receive the beam-shaped first and second laser beam components propagating along the common propagation path portion and direct them in accordance with their respective states of the optical property for propagation along separate first and second output path portions.

2. The beam switching system of claim 1, in which the optical property is phase and the relative change in the states of the property is a change in phase displacement between the first and second beam components.

3. The beam switching system of claim 1, in which the set of one or more optical components includes a phase-changing device positioned in one of the first and second propagation path portions and a polarizing beam combiner positioned to combine the first and second propagation path portions into the common propagation path portion.

4. The beam switching system of claim 3, in which the phase-changing device includes a half-wave plate.

5. The beam switching system of claim 1, in which the beam switching device comprises two optically associated acousto-optic modulators selectively providing in response to the control signal the first and second laser beam components propagating sequentially along the respective first and second propagation path portions.

6. The beam switching system of claim 5, in which the two optically associated acousto-optic modulators are positioned in optical series.

7. The beam switching system of claim 1, in which the beam splitter comprises a polarizing beam splitter that directs the beam-shaped first and second laser beam components in accordance with their polarization states.

8. The beam switching system of claim 1, in which the shaping of spatial distributions of light energy by the imaged optics assembly results in a uniform spatial distribution.

9. The beam switching system of claim 1, further comprising a beam expander positioned between the imaged optics assembly and the polarizing beam splitter along the common propagation path portion to set the beam diameter of the beam-shaped first and second laser beam components propagating along the separate first and second output path portions.

10. The beam switching system of claim 9, in which the beam expander is of a variable beam expansion type.

11. The beam switching system of claim 1, further comprising first and second beam positioning mechanisms optically associated with the respective beam-shaped first and second laser beam components.

12. The beam switching system of claim 1, further comprising one or more beam expanders optically associated with the first and second laser beam components to establish for incidence on the imaged optics assembly light beams of desired light energy spatial distributions and diameters.

13. The beam switching system of claim 12, in which the desired light energy spatial distributions are of Gaussian shape.

14. The beam switching system of claim 12, in which the first and second laser beam components propagate from separate laser sources that are optically associated with different beam expanders.

15. The beam switching system of claim 12, in which the first and second laser beam components are derived from an output beam emitted by one laser source and propagating through the one beam expander.

16. The beam switching system of claim 1, further comprising a beam switching device that receives an incident laser beam and, in response to a control signal, selectively directs the laser beam to sequentially form the first and second laser components propagating along the first and second propagation path portions.

17. The beam switching system of claim 16, further comprising a beam expander positioned to receive the laser beam before its incidence on the beam switching device to establish for incident on the imaged optics assembly the first and second beam components of a desired light energy spatial distribution and diameter.

18. The beam switching system of claim 17, in which the desired light energy spatial distribution is of Gaussian shape.
